(19) United States
(12) Patent Application Publication
(10) Pub. No.: US 2012/0046881 A1
(43) Pub. Date: Feb. 23, 2012

(54) APPARATUS AND METHOD FOR MEASUREMENT OF VOLATILE ORGANIC COMPOUND EMISSIONS

(75) Inventor: Richard R. CANNON, Fredericktown, OH (US)

(73) Assignee: ARIEL CORPORATION, Mt. Vernon, OH (US)

(21) Appl. No.: 12/858,030

(22) Filed: Aug. 17, 2010

(51) Int. Cl. G06F 19/00; G01N 27/00

(52) U.S. Cl. 702/25; 422/82.01

(57) ABSTRACT

A method and apparatus are provided for measurement of VOC emissions. The apparatus includes at least one memory including computer program code, and at least one processor. The at least one memory and the computer program code are configured to, with the at least one processor, cause the apparatus at least to receive a plurality of electronic pulses based on a flow of a volatile organic compound-containing liquid through a measurement unit. The at least one memory and the computer program code are further configured to, with the at least one processor, cause the apparatus at least to generate metadata based on the received plurality of electronic pulses, store the generated metadata, and display the stored metadata. The metadata includes information relating to one of a flowrate, a total amount, and a total elapsed time of dispensing the volatile organic compound-containing liquid.

### BACKGROUND

1. Field

Embodiments of the invention generally relate to a volatile organic compound (VOC) emission measurement system. More particularly, certain embodiments of the invention relate to a system, an apparatus, a method and a computer program product for measuring VOC emissions from, for example, a spray paint booth.

2. Description of the Related Art

The United States Environmental Protection Agency (EPA) requires manufacturers to obtain permits to demonstrate that a company complies with federal and state air pollution control rules. Other countries have similar requirements. The permits usually contain conditions related to acceptable air emissions, operating conditions and record keeping requirements for the company.

Operations that use VOC-containing liquids, for example, painting operations, are regulated because VOCs and hazardous air pollutants (HAPs) contribute to the formation of photochemical smog, and can be harmful to human health. Many of the VOCs and HAPs are suspected carcinogens.

Currently, manufacturing operations that use VOC-containing liquids use a manual system for recording an amount of and time elapsed for dispensed VOC-containing liquids, which is inefficient and inaccurate.

### SUMMARY

In accordance with an embodiment of the invention, there is provided a system which includes a measuring unit configured to generate a plurality of electronic pulses based on a flow of a volatile organic compound-containing liquid. The system further includes a controller. The controller is configured to generate metadata based on the generated plurality of electronic pulses. The metadata includes information relating to one of a flowrate, a total amount, and a total elapsed time of dispensing the volatile organic compound-containing liquid, and an amount of volatile organic compounds passed through the measuring unit per volume unit of the volatile organic compound-containing liquid to determine an amount of emitted volatile organic compounds. The controller is further configured to display the generated metadata. The system further includes a cleaning unit configured to flush the measuring unit of any remaining volatile organic compound-containing liquid.

In accordance with another embodiment of the invention, there is provided an apparatus which includes at least one memory including computer program code, and at least one processor. The at least one memory and the computer program code are configured to, with the at least one processor, cause the apparatus at least to receive a plurality of electronic pulses based on a flow of a volatile organic compound-containing liquid through a measurement unit. The at least one memory and the computer program code are further configured to, with the at least one processor, cause the apparatus at least to generate metadata based on the received plurality of electronic pulses, store the generated metadata, and display the stored metadata. The metadata includes information relating to one of a flowrate, a total amount, and a total elapsed time of dispensing the volatile organic compound-containing liquid, and an amount of volatile organic compounds passed through the measuring unit per volume unit of the volatile organic compound-containing liquid to determine an amount of emitted volatile organic compounds.

In accordance with another embodiment of the invention, there is provided an apparatus which includes at least one memory including computer program code, and at least one processor. The at least one memory and the computer program code are configured to, with the at least one processor, cause the apparatus at least to receive one of a plurality of electronic pulses and metadata from a remote controller based on a flow of a VOC-containing liquid through a measuring unit. When receiving the plurality of electronic pulses, the at least one memory and the computer program code are further configured to, with the at least one processor, cause the apparatus at least to generate metadata based on the received plurality of electronic pulses. The at least one memory and the computer program code are further configured to, with the at least one processor, cause the apparatus at least to store the metadata and display the stored metadata. The metadata includes information relating to one of a flowrate, a total amount, and a total elapsed time of dispensing the volatile organic compound-containing liquid, and an amount of volatile organic compounds passed through the measuring unit per volume unit of the volatile organic compound-containing liquid to determine an amount of emitted volatile organic compounds.

### BRIEF DESCRIPTION OF THE DRAWINGS

Reference will now be made in detail to the embodiments of the invention, examples of which are illustrated in the accompanying drawings.

FIG. 1 illustrates a block diagram of a VOC emission measurement system, in accordance with an embodiment of the invention.

FIG. 2 illustrates a block diagram of a measuring unit in the VOC emission measurement system, in accordance with an embodiment of the invention.

FIG. 3 illustrates a block diagram of a controller in the VOC emission measurement system, in accordance with an embodiment of the invention.

FIG. 4 illustrates a block diagram of a cleaning unit in the VOC emission measurement system, in accordance with an embodiment of the invention.

FIG. 5 illustrates a block diagram of a VOC emission measurement system, in accordance with another embodiment of the invention.

FIG. 6 illustrates a flow diagram of a method for measuring VOC emissions, in accordance with an embodiment of the invention.

FIG. 7 illustrates a flow diagram of a method for measuring VOC emissions, in accordance with another embodiment of the invention.

### DETAILED DESCRIPTION

It will be readily understood that the components of the invention, as generally described and illustrated in the figures herein, may be arranged and designed in a wide variety of different configurations. Thus, the following detailed description of the embodiments of the system, the apparatus, the method and the computer program product, as represented in the attached figures, is not intended to limit the scope of the invention as claimed, but is merely representative of selected embodiments of the invention.

For example, while the exemplary embodiments described below are directed to the measurement of VOC emissions from a spray paint booth, it should be appreciated that the exemplary embodiments of the invention are not limited for use with this one particular application. The exemplary embodiments of the invention may be used for any system where the measurement of VOC emissions is desired, for example, during the manufacture or application of petroleum products, insecticides, solvents, cleaners, refrigerants, etc.

If desired, the different functions discussed below may be performed in a different order and/or concurrently with each other. Furthermore, if desired, one or more of the above-described functions may be optional or may be combined. As such, the foregoing description should be considered as merely illustrative of the principles, teachings and embodiments of this invention, and not in limitation thereof.

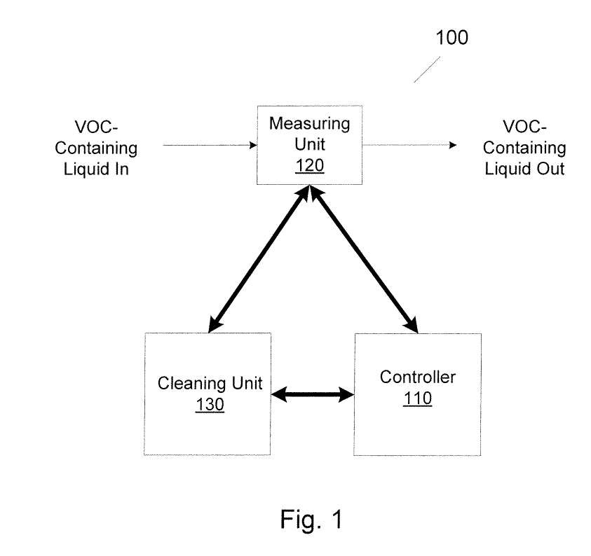

FIG. 1 illustrates a block diagram of a VOC emission measurement system, in accordance with an embodiment of the invention. As illustrated in FIG. 1, the system 100 may include a controller 110 and a measuring unit 120.

The measuring unit 120 may measure an amount of dispensed VOC-containing liquid and an elapsed time of dispensing the VOC-containing liquid (i.e., an amount of paint sprayed in a spray paint booth over a period of time).

The controller 110 may process the measured amount of the dispensed VOC-containing liquid and the elapsed time of dispensing, and generate metadata relating to, for example, a flowrate of the dispensed VOC-containing liquid, a total amount of the dispensed VOC-containing liquid, and a total elapsed time of dispensing, and an amount of VOCs passed through the measuring unit per volume unit of the VOC-containing liquid (i.e., 3.44 lbs. of VOCs per gallon of primer/paint sprayed) to determine an amount of emitted VOCS (i.e., if 128 ounces (1 gallon) of the VOC-containing liquid is sprayed, then 3.44 lbs. of the VOC is emitted).

The metadata may be generated for a specific operator and a specific spray paint booth, or to identify specific parts that have been coated with the VOC-containing liquid.

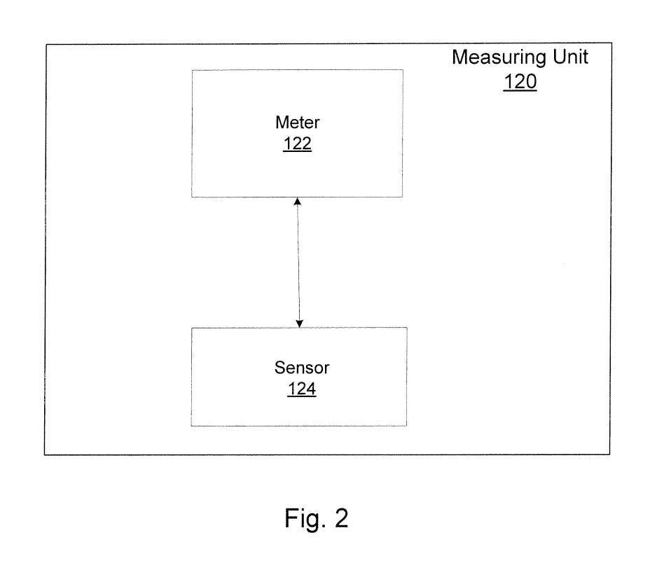

FIG. 2 illustrates a block diagram of a measuring unit in the volatile organic compound emission measurement system, in accordance with an embodiment of the invention. As illustrated in FIG. 2., the measuring unit 120 may include a meter 122 and a sensor 124.

The meter 122 may include any type of flow meter that may measure a flow of the VOC-containing liquid through the measuring unit 120. For example, a helical meter may be used that generates a plurality of electronic pulses that vary with an amount of the VOC-containing liquid flowing through the meter 122. In a spray paint booth application, the VOC-containing liquid may include, for example, paint, primer, or solvent. The meter 122 may include, for example, a pair of rotating shafts having helixes that mesh together, so that a flow of the VOC-containing liquid through the meter 122 forces the pair of shafts to rotate. At least one of the shafts may include a gear or a sprocket that may include a fixed number of teeth which rotate with the rotation of the pair of rotating shafts.

The sensor 124 may be arranged within a close proximity of the meter 122, so that the sensor 124 may detect the flow of the VOC-containing liquid through the meter 122 (i.e., movement of the teeth on the rotating gear or sprocket). Based on the flow of the VOC-containing liquid through the meter 122, the sensor 124 may generate a plurality of electronic pulses (i.e., count the number of teeth that rotate past the sensor 124 and generate a plurality of electronic pulses based on this count).

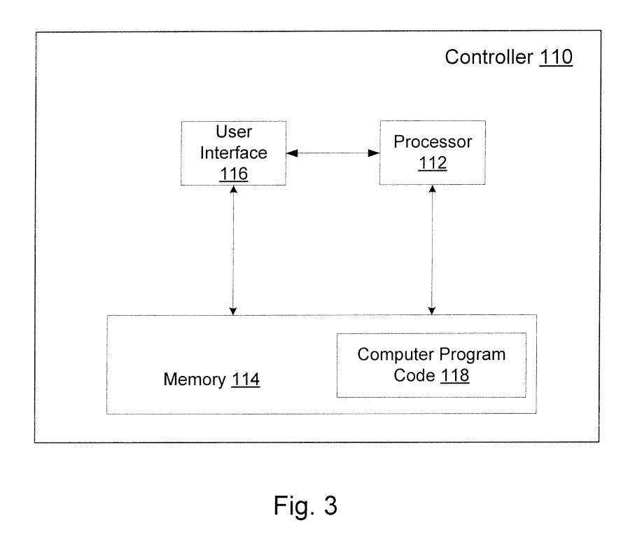

FIG. 3 illustrates a block diagram of a controller in the volatile organic compound emission measurement system, in accordance with an embodiment of the invention. As illustrated in FIG. 3, the controller 110 may include, for example, a programmable logic controller, that may control the operation of the measuring unit 120. The controller 110 may include a processor 112, a memory 114 and a user interface 116.

While a single processor 112 and a single memory 114 are illustrated in FIG. 3, multiple processors and multiple memory may be utilized according to other embodiments.

The processor 112 may receive the plurality of electronic pulses and may generate the metadata relating to, for example, the flowrate of the dispensed VOC-containing liquid, the total amount of the dispensed VOC-containing liquid, and the total elapsed time of dispensing, and an amount of VOCs passed through the measuring unit per volume unit of the VOC-containing liquid to determine an amount of emitted VOCs. The metadata may be generated for a specific operator and a specific spray paint booth, or to identify specific parts that have been coated with the VOC-containing liquid.

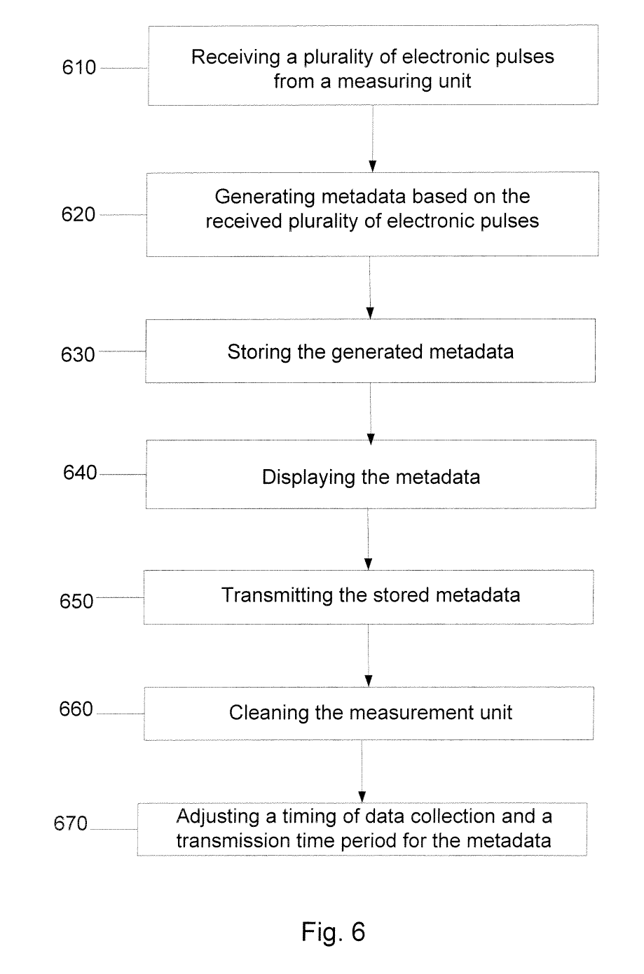

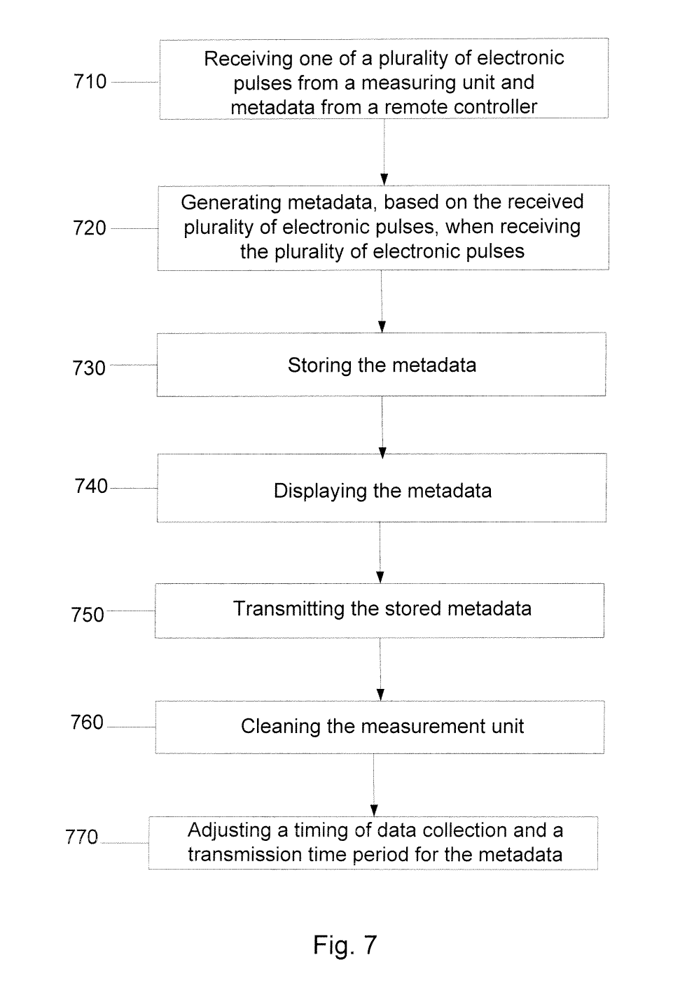

Once the metadata is generated, the processor 112 may store the metadata in the memory 114. The memory 114 may be coupled to the processor 112 for storing information and instructions to be executed by the processor 112. The memory 114 may include computer program code 118 embodied on a computer readable non-transitory medium. The computer program code 118 may be encoded with instructions to control the processor 112 to perform the methods discussed below and illustrated in FIGS. 6 and 7.

The user interface 116 may include, for example, a human machine interface, that may display all the metadata stored in the memory 114, organized, for example, by operator, time period, VOC-containing liquid type, or combinations thereof. The user interface 116 may serve as a file transfer protocol server and interface to the Ethernet.

The processor 112 may further transmit the metadata via a wired or wireless communication (i.e., via email), for example, as individual metadata, groups of metadata, or screenshots of gathered metadata requested by an operator or at pre-set time periods, for example, every 24 hours, to a designated recipient. The designated recipient may include, for example, an operator, a regulating body, such as the United States Environment Protection Agency, an auditor, and an external memory location. The timing of data collection by the measuring unit 120, the specific metadata to be transmitted and the pre-set time period for metadata transmission may be adjusted using a programmable platform on the user interface 116.

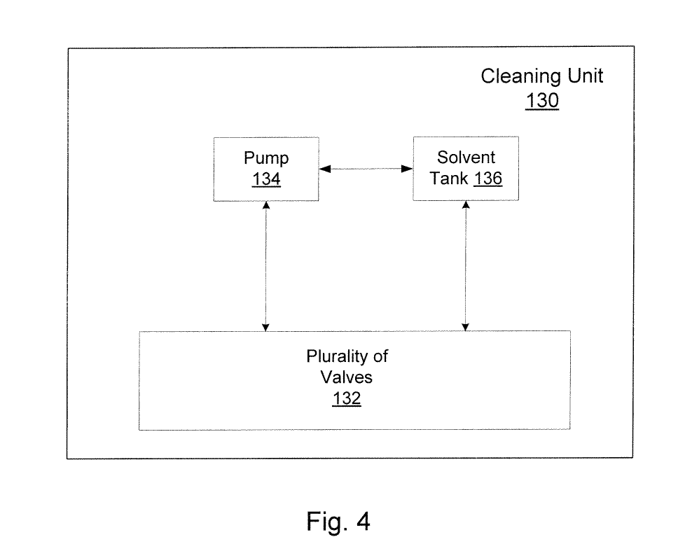

The system 100 may further include a cleaning unit 130, as illustrated in FIG. 4, for cleaning the measuring unit 120. The cleaning unit 130 may include a plurality of valves 132, a pump 134 and a solvent tank 136. The controller 110 may be configured to program the cleaning unit 130 to clean the measuring unit 120 at pre-set times, for example, daily or weekly. The controller 110 may be configured to operate a valve 132 to isolate the meter 122 and the sensor 124 from a flow of solvent through the measuring unit 120. The controller 110 may also be configured to operate another valve 132, the pump 134 and the solvent tank 136 to pump solvent from the solvent tank 136 to flush the measuring unit 120 of the VOC-containing liquid.

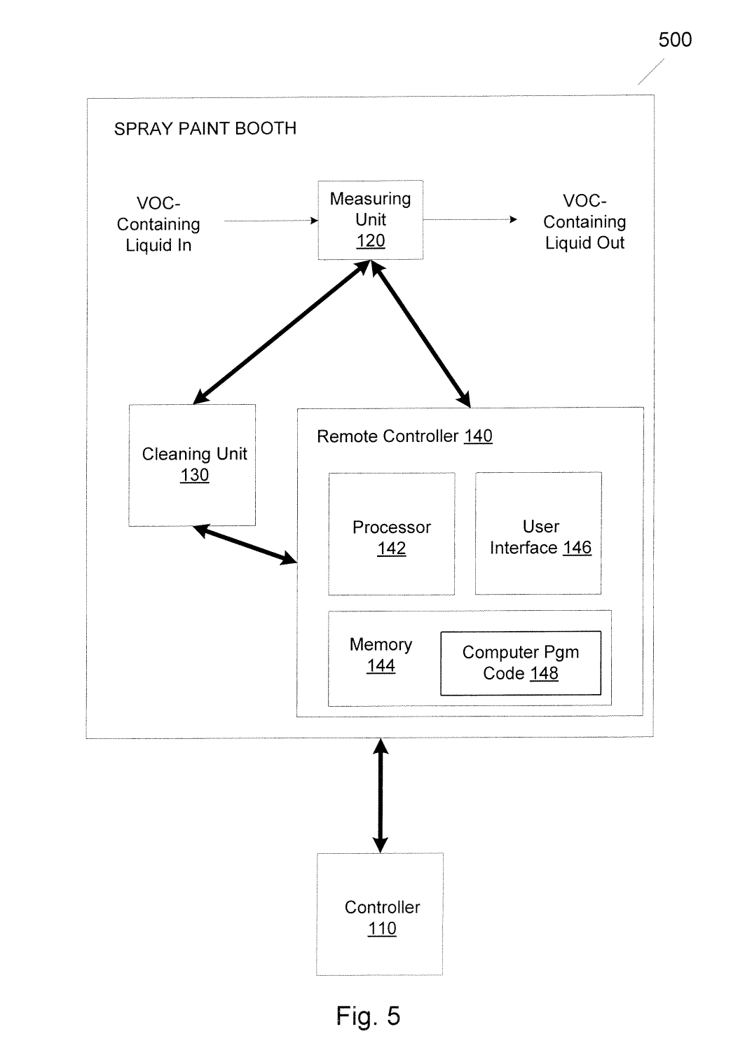

FIG. 5 illustrates a block diagram of a VOC emission measurement system, in accordance with another embodiment of the invention. As illustrated in FIG. 5, in certain embodiments, the system 500 may include the controller 110, the measuring unit 120 and a remote controller 140. In this case, only one spray paint booth is remotely monitored. Certain embodiments of the invention may include a plurality of measuring units 120 and remote controllers 140 for applications where, for example, multiple spray paint booths are to be remotely monitored. In this case, each spray paint booth may include one measuring unit 120 and one remote controller 140. The controller 110 and the remote controller 140 may be configured to communicate via a Modbus network using wired or wireless communication, including, for example, satellite communication.

The following description of certain embodiments of the invention will be described for the system 500, as illustrated in FIG. 5, including one controller 110, one measuring unit 120 and one remote controller 140, where a spray paint booth is remotely monitored.

The measuring unit 120 of the system 500 may include the meter 122 and the sensor 124 (not illustrated) and may function in the same manner as discussed above for the system 100.

The remote controller 140 may include, for example, a programmable logic controller, that may control the operation of the measuring unit 120. The remote controller 140 may include a processor 142, a memory 144 and a user interface 146. While a single processor 142 and a single memory 144 are provided, multiple processors and multiple memory may be utilized according to other embodiments.

The processor 142 may receive the plurality of electronic pulses from the measuring unit 120 and may generate metadata, relating to, for example, the flowrate of the dispensed VOC-containing liquid, the total amount of the dispensed VOC-containing liquid, and the total elapsed time of dispensing, and an amount of VOCs passed through the measuring unit per volume unit of the VOC-containing liquid to determine an amount of emitted VOCs, for the spray paint booth. The metadata may be generated for a specific operator and a specific spray paint booth, or to identify specific parts that have been coated with the VOC-containing liquid. Once the metadata is generated, the processor 142 may store the metadata in the memory 144. The memory 144 may be coupled to the processor 142 for storing information and instructions to be executed by the processor 142. The memory 144 may include computer program code 146 embodied on a computer readable non-transitory medium. The computer program code 146 may be encoded with instructions to control the processor 142 to perform the methods discussed below and illustrated in FIGS. 6 and 7.

As discussed for the system 100, the controller 110 of the system 500 may include the processor 112, the memory 114 and the user interface 116 (not illustrated). The processor 112 may retrieve the metadata from the memory 144 of the remote controller 140, and may store the metadata in the memory 114. As discussed above for the system 100, the displayed metadata may be organized, for example, by operator, spray paint booth, time period, VOC-containing liquid type, or combinations thereof. The user interface 116 may serve as a file transfer protocol server and interface to the Ethernet. The processor 112 may further transmit the metadata via a wired or wireless communication, as discussed above for the system 100.

In certain embodiments of the invention, the processor 142 may receive the plurality of electronic pulses from the measuring unit 120 and may store the plurality of electronic pulses in the memory 144, instead of generating metadata based on the plurality of electronic pulses. In these embodiments, the processor 112 of the controller 110 may retrieve the plurality of electronic pulses in the memory 144, and may generate the metadata, as discussed above in the system 100. Hence, metadata relating to the flowrate of, the amount of, and the time elapsed dispensing the VOC-containing liquid may be generated in either the controller 110 or the remote controller 140. Additionally, metadata relating to an amount of VOCs passed through the measuring unit per volume unit of the VOC-containing liquid to determine an amount of emitted VOCs may also be generated in either the controller 110 or the remote controller 140.

The system 500 may further include the cleaning unit 130, as illustrated in FIG. 4 and discussed for the system 100, configured to clean the measuring unit 120. The cleaning of the measuring unit 120 may be locally controlled by the remote controller 140 or remotely controlled by the controller 110.

For certain embodiments that include a plurality of measuring units 120 and a plurality of remote controller 140 for remotely monitoring and controlling a plurality of spray paint booths, the processor 112 may retrieve the metadata from the memory 144 of each remote controller 140, may store all the metadata in the memory 114, and may display all the organized metadata on the user interface 116 for each respective spray paint booth. These embodiments of the invention may also include a plurality of cleaning units 130 (i.e., one cleaning unit 130 configured for each measuring unit 120). Each cleaning unit 130 may be locally controlled by the remote controller 140 or remotely controlled by the controller 110.

The processors 112 and 142 may be of any type suitable to the local technical environment, and may include one or more of general purpose computers, special purpose computers, microprocessors, digital signal processors (DSPs) and processors based on multi-core processor architecture, as non-limiting examples.

The memory 114 and 144 may be of any type suitable to the local technical environment and may be implemented using any suitable data storage technology, machine or computer readable storage medium, such as semiconductor-based memory devices, flash memory, magnetic memory devices and systems, optical memory devices and systems, fixed memory and removable memory, as non-limiting examples.

FIG. 6 illustrates a flow diagram of a method for measuring VOC emissions, in accordance with an embodiment of the invention. The method may include receiving a plurality of electronic pulses from a measuring unit based on a flow of a VOC-containing liquid through the measuring unit (step 610). The method may further include generating metadata based on the received plurality of electronic pulses (step 620), and storing the metadata in a memory (step 630). The generated metadata may relate to at least one of a flowrate of the dispensed VOC-containing liquid, a total amount of the dispensed VOC-containing liquid, and a total elapsed time of dispensing, and an amount of VOCs passed through the measuring unit per volume unit of the VOC-containing liquid to determine an amount of emitted VOCs. The metadata may be generated for a specific operator, a specific spray paint booth, or to identify specific parts that have been coated with the VOC-containing liquid.

As illustrated in FIG. 6, the method may include displaying the stored metadata (step 640). The method may also include transmitting the metadata to a designated recipient (step 650). The designated recipient may include, for example, an operator, an auditor, and an external memory location. The method may further include cleaning the measurement unit (step 660), and adjusting a timing of data collection by the measuring unit 120, and a transmission time period for the metadata using a programmable platform on a user interface (step 670).

The step of receiving may include receiving the plurality of electronic pulses from a measuring unit including any type of flowmeter that may measure a flow of the VOC-containing liquid through the measuring unit and a sensor configured to generate the plurality of electronic pulses. The measuring unit may be locally or remotely located.

The step of displaying the metadata may include organizing and displaying the metadata for a specific operator, spray paint booth number, or time period.

The step of transmitting may include transmitting the metadata via a wired or wireless communication, for example, as individual metadata, groups of metadata, or screenshots of gathered metadata requested by an operator or at pre-set time periods, for example, every 24 hours, to a designated recipient. The designated recipient may include, for example, an operator, an auditor, and an external memory location.

The step of cleaning the measurement unit may include operating a plurality of valves, a pump and a solvent tank to isolate the meter and the sensor of the measurement unit, to flow a solvent through the measurement unit, and to flush the measurement unit of the remaining VOC-containing liquid.

FIG. 7 illustrates a flow diagram of a method for measuring VOC emissions, in accordance with another embodiment of the invention. The method may include receiving one of a plurality of electronic pulses and metadata from a remote controller based on a flow of a VOC-containing liquid through a measuring unit (step 710). The method may further include, when receiving the plurality of electronic pulses, generating metadata based on the received plurality of electronic pulses (step 720). Further, the method may include storing the metadata in a memory (step 730). The metadata may relate to at least one of a flowrate of the dispensed VOC-containing liquid, a total amount of the dispensed VOC-containing liquid, and a total elapsed time of dispensing, and an amount of VOCs passed through the measuring unit per volume unit of the VOC-containing liquid to determine an amount of emitted VOCs. The metadata may be generated for a specific operator, a specific spray paint booth, or to identify specific parts that have been coated with the VOC-containing liquid. The method may further include displaying the stored metadata (step 740).

Steps 750 to 770 of the method, as illustrated in FIG. 7, may be similar to steps 650 to 670 discussed above for the method illustrated in FIG. 6.

Further to the discussion above, it is to be understood that in an embodiment of the invention, the steps and the like may be changed without departing from the spirit and scope of the present invention. In addition, the method described in FIGS. 6 and 7 may be repeated numerous times.

A computer program code 118, 148 according to certain embodiments of the invention, may be composed of modules that are in operative communication with one another, and which are designed to pass information or instructions to a communication device, such as a mobile node or a user equipment, a personal computer, a handheld device, such as a mobile, a cellular telephone, or a personal digital assistant (PDA) having wireless communication capabilities, a portable computer having wireless communication capabilities and a portable unit or a terminal that incorporates combinations of such functions, as non-limiting examples.

The computer program code 118, 148 may be configured to operate on a general purpose computer or an application specific integrated circuit (ASIC).

The computer readable (i.e., non-transitory) storage medium may include any media or means that may contain, store, communicate, propagate or transport the instructions for use by or in connection with an instruction execution system, apparatus, or device, for example, a disk media, computer memory, or other storage device. Non-transitory storage medium does not include a transitory signal. Examples of non-transitory storage medium may include, for example, a computer-readable medium, a computer distribution medium, a computer-readable storage medium, and a computer program product.

The embodiments of the invention discussed above may be implemented by hardware, computer software executable by one or more of the processor 112 of the controller 110 and the processor 142 of the remote controller 140, or by a combination of hardware and software.

The software and/or hardware may reside on the controller 110, the remote controller 140, or other mobile communication devices. If desired, part of the software and/or hardware may reside on the controller 110, part of the software and/or hardware may reside on the controller 140, and part of the software and/or hardware may reside on other mobile communication devices. In an embodiment of the invention, software, or an instruction set may be maintained on any one of various conventional computer-readable media.

In accordance with an embodiment of the invention, there is provided a computer program product embodied on a computer readable storage medium. The computer program product is encoded with instructions to control a processor to perform a process. The process includes receiving a plurality of electronic pulses based on a flow of a volatile organic compound-containing liquid through a measurement unit, and generating metadata based on the received plurality of electronic pulses. The metadata includes information relating to one of a flowrate, a total amount, and a total elapsed time of dispensing the volatile organic compound-containing liquid, and an amount of VOCs passed through the measuring unit per volume unit of the VOC-containing liquid to determine an amount of emitted VOCs. The process further includes storing the generated metadata, and displaying the stored metadata.

In accordance with an embodiment of the invention, there is provided a computer program product embodied on a computer readable storage medium. The computer program product is encoded with instructions to control a processor to perform a process. The process includes receiving one of a plurality of electronic pulses and metadata from a remote controller based on a flow of a VOC-containing liquid through a measuring unit. When receiving the plurality of electronic pulses, the method further includes generating metadata based on the received plurality of electronic pulses, storing the metadata, and displaying the stored metadata. The metadata includes information relating to one of a flowrate, a total amount, and a total elapsed time of dispensing the volatile organic compound-containing liquid, and an amount of VOCs passed through the measuring unit per volume unit of the VOC-containing liquid to determine an amount of emitted VOCs.

One having ordinary skill in the art will readily understand that the invention as discussed above may be practiced with steps in a different order, and/or with hardware elements in configurations which are different than those which are disclosed. Therefore, although the invention has been described based upon these preferred and non-limiting embodiments, it would be apparent to those of skill in the art that certain modifications, variations, and alternative constructions would be apparent, while remaining in the spirit and scope of the invention. Thus, the example embodiments do not limit the invention to the particular listed devices and technologies. In order to determine the metes and bounds of the invention, therefore, reference should be made to the appended claims.

We claim:

1. A system for measuring volatile organic compound emissions, the system comprising:
a measuring unit configured to generate a plurality of electronic pulses based on a flow of a volatile organic compound-containing liquid;
a controller configured to
generate metadata based on the generated plurality of electronic pulses, wherein the metadata comprises information relating to one of a flowrate, a total amount, and a total elapsed time of dispensing the volatile organic compound-containing liquid, and an amount of volatile organic compounds passed through the measuring unit per volume unit of the volatile organic compound-containing liquid to determine an amount of emitted volatile organic compounds, and
display the generated metadata; and
a cleaning unit configured to flush the measuring unit of any remaining volatile organic compound-containing liquid.

2. An apparatus, comprising:
at least one memory including computer program code; and
at least one processor,
wherein the at least one memory and the computer program code are configured to, with the at least one processor, cause the apparatus at least to:
receive a plurality of electronic pulses based on a flow of a volatile organic compound-containing liquid through a measurement unit,
generate metadata based on the received plurality of electronic pulses, wherein the metadata comprises information relating to one of a flowrate, a total amount, and a total elapsed time of dispensing the volatile organic compound-containing liquid, and an amount of volatile organic compounds passed through the measuring unit per volume unit of the volatile organic compound-containing liquid to determine an amount of emitted volatile organic compounds,
store the generated metadata, and
display the stored metadata.

3. The apparatus of claim 2, wherein the at least one memory and the computer program code are configured to, with the at least one processor, cause the apparatus at least to receive the plurality of electronic pulses from the measurement unit comprising a flowmeter and a sensor.

4. The apparatus of claim 2, wherein the at least one memory and the computer program code are configured to, with the at least one processor, cause the apparatus at least to generate the metadata for one of a specific operator, a specific VOC-containing liquid application location, and a specific part coated with the VOC-containing liquid.

5. The apparatus of claim 2, wherein the at least one memory and the computer program code are configured to, with the at least one processor, cause the apparatus at least to display the stored metadata based on one of an operator, a time period, a VOC-containing liquid type, or combinations thereof.

6. The apparatus of claim 2, wherein the at least one memory and the computer program code are configured to, with the at least one processor, cause the apparatus at least to
transmit the stored metadata to a remotely-located recipient via a wired or wireless communication,
clean the measurement unit, and
adjust a time period for receiving the plurality of electronic pulses from the measurement unit and a time period for transmitting the metadata to the remotely-located recipient.

7. The apparatus of claim 6, wherein the at least one memory and the computer program code are configured to, with the at least one processor, cause the apparatus at least to transmit the stored metadata to a remotely-located recipient, wherein the transmitted metadata comprises one of individual metadata, groups of metadata, and screenshots of gathered metadata requested by an operator or transmitted at a pre-set time period.

8. The apparatus of claim 6, wherein the at least one memory and the computer program code are configured to, with the at least one processor, cause the apparatus at least to transmit the stored metadata to a remotely-located recipient, wherein the remotely-located recipient comprises one of an operator, an auditor, and an external memory location.

9. The apparatus of claim 6, wherein the at least one memory and the computer program code are configured to, with the at least one processor, cause the apparatus at least to clean the measurement unit by operating a plurality of valves, a pump, and a solvent tank to flush the measurement unit of the VOC-containing liquid.

10. An apparatus, comprising:
at least one memory including computer program code; and
at least one processor,
wherein the at least one memory and the computer program code are configured to, with the at least one processor, cause the apparatus at least to:
receive one of a plurality of electronic pulses and metadata from a remote controller based on a flow of a VOC-containing liquid through a measuring unit,
when receiving the plurality of electronic pulses, generate metadata based on the received plurality of electronic pulses,
store the metadata, and
display the stored metadata,
wherein the metadata comprises information relating to one of a flowrate, a total amount, and a total elapsed time of dispensing the volatile organic compound-containing liquid, and an amount of volatile organic compounds passed through the measuring unit per volume unit of the volatile organic compound-containing liquid to determine an amount of emitted volatile organic compounds.

11. The apparatus of claim 10, wherein the at least one memory and the computer program code are configured to, with the at least one processor, cause the apparatus at least to receive the plurality of electronic pulses from a measurement unit comprising a flowmeter and a sensor.

12. The apparatus of claim 10, wherein the at least one memory and the computer program code are configured to, with the at least one processor, cause the apparatus at least to generate the metadata for one of a specific operator, a specific VOC-containing liquid application location, and a specific part coated with the VOC-containing liquid.

13. The apparatus of claim 10, wherein the at least one memory and the computer program code are configured to, with the at least one processor, cause the apparatus at least to display the stored metadata based on one of an operator, a time period, a VOC-containing liquid type, or combinations thereof.

14. The apparatus of claim 10, wherein the at least one memory and the computer program code are configured to, with the at least one processor, cause the apparatus at least to
transmit the stored metadata to a remotely-located recipient via a wired or wireless communication,
clean the measurement unit, and
adjust a time period for receiving the plurality of electronic pulses from the measurement unit and a time period for transmitting the metadata to the remotely-located recipient.

15. The apparatus of claim 14, wherein the at least one memory and the computer program code are configured to, with the at least one processor, cause the apparatus at least to transmit the stored metadata to a remotely-located recipient, wherein the transmitted metadata comprises one of individual metadata, groups of metadata, and screenshots of gathered metadata requested by an operator or transmitted at a pre-set time period.

16. The apparatus of claim 14, wherein the at least one memory and the computer program code are configured to, with the at least one processor, cause the apparatus at least to transmit the stored metadata to a remotely-located recipient, wherein the remotely-located recipient comprises one of an operator, an auditor, and an external memory location.

17. The apparatus of claim 14, wherein the at least one memory and the computer program code are configured to, with the at least one processor, cause the apparatus at least to clean the measurement unit by operating a plurality of valves, a pump, and a solvent tank to flush the measurement unit of the VOC-containing liquid.
